(19) United States
(12) Patent Application Publication
(10) Pub. No.: US 2024/0409377 A1
(43) Pub. Date: Dec. 12, 2024

(54) Portable Winch Device

(71) Applicant: Michael Bisila, Isanti, MN (US)

(72) Inventor: Michael Bisila, Isanti, MN (US)

(21) Appl. No.: 18/733,097

(22) Filed: Jun. 4, 2024

Related U.S. Application Data
(60) Provisional application No. 63/506,684, filed on Jun. 7, 2023.

(51) Int. Cl. B66D 3/00

(52) U.S. Cl. CPC B66D 3/006

(57) ABSTRACT

A portable winch device is disclosed, which is a winch with its own power source so that it can be used at any time. The portable winch device comprises a base component that is configured in a rectangular box which encloses the winch component. The winch component is a 12v electric winch, powered by a removable battery. The removable battery sits inside the base component with an adapter to go from the battery to the winch control box for power. Further, soft shackles and/or carabiners are positioned to come out the back of the base component and are attached to the winch component inside the base component. The soft shackles are used to anchor the base component in place. Further, a small remote is used to control the device.

### CROSS-REFERENCE TO RELATED APPLICATION

The present application claims priority to, and the benefit of, U.S. Provisional Application No. 63/506,684, which was filed on Jun. 7, 2023, and is incorporated herein by reference in its entirety.

### FIELD OF THE INVENTION

The present invention relates generally to the field of portable winch devices. More specifically, the present invention relates to a portable winch with its own power source that can be attached to anything. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in portable winch devices. Generally, there are many scenarios where additional assistance is needed in moving, lifting or hauling an object or vehicle. For example, it can be difficult to load heavy items into a trailer. It is also hard to move or pull vehicles that have become stuck. Further, when on the go, it may be difficult to find an effective solution, especially if there is no available power source.

With the proliferation of off-road vehicles for recreational and/or work-related activities, vehicle operators often find themselves in situations requiring a suitable means for extricating their vehicle and/or vehicles of others and/or equipment or the like from problematic situations wherein a winch is necessary or desired. However, most winches are fixed and generally limited in their pulling direction.

Accordingly, there is a demand for an improved portable winch device that can be used at any time. More particularly, there is a demand for a portable winch device that includes an independent power source.

Therefore, there exists a long felt need in the art for a portable winch device that provides users with a portable winch with its own power source that can be attached to anything. There is also a long felt need in the art for a portable winch device that assists users in moving heavy items off of the ground, pulling items onto trailers, pulling vehicles, etc. Further, there is a long felt need in the art for a portable winch device that includes an independent power source so that it can be operated in all scenarios. Moreover, there is a long felt need in the art for a device that ensures that a ready to use winch is on hand when needed. Further, there is a long felt need in the art for a portable winch device that comprises a small remote. Finally, there is a long felt need in the art for a portable winch device that is powered by a removable battery.

The subject matter disclosed and claimed herein, in one embodiment thereof, comprises a portable winch device. The device is a winch with its own power source so that it can be used at any time. The portable winch device comprises a base component that is configured in a rectangular box which encloses the winch component. The winch component is a 12v electric winch, powered by a removable battery. The removable battery sits inside the base component with an adapter to go from the battery to the winch control box for power. Further, soft shackles and/or carabiners are positioned to come out the back of the base component and are attached to the winch component inside the base component. The soft shackles are used to anchor the base component in place. Further, a small remote is used to control the device.

In this manner, the portable winch device of the present invention accomplishes all of the forgoing objectives and provides users with a portable winch with its own power source. The device is a winch with a remote control. The device is powered via a removable battery.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable winch device. The device is a winch with its own power source so that it can be used at any time. The portable winch device comprises a base component which encloses a winch component. The winch component is powered by a removable battery. The removable battery sits inside the base component with an adapter to go from the battery to the winch control box for power. Further, soft shackles and/or carabiners are positioned to come out the back of the base component and are attached to the winch component inside the base component. The soft shackles are used to anchor the base component in place.

In one embodiment, the portable winch device is a winch with its own power source that can be attached to anything. The portable winch device assists users in moving heavy objects off of the ground, pulling items onto trailers, pulling vehicles, etc., or any other suitable pulling of objects as is known in the art. The portable winch device can be easily transported and ensures that a ready-to-use winch is on hand when needed.

In one embodiment, the portable winch device comprises a base component configured as a rectangular box which encloses a winch component. The base component can be any suitable shape and size as is known in the art. Further, the base component comprises a bottom, opposing right and left sides, opposing front and back sides, and an open interior that houses the winch component. Typically, the open interior is secured by a hinged lid component or any other suitable lid component as is known in the art.

In one embodiment, the winch component is a 12v electric winch, powered by a removable battery. Specifically, the winch component includes a motor, a drum/axle coupled to the motor, and a winch cable. The motor is electrically coupled to the battery and is selectively operated by a winch control box. Further, upon activation from the winch control box, the winch control box draws power from the battery to provide power to the winch component. The motor is electrically driven and connects via suitable circuitry with the battery of the device. Further, a control toggle switch acts to control the motor between off, forward motion and reverse motion. This winch component typically has a 2500 pound stall capacity, however winches of more or less capacity could be adapted to operate with the device of the invention. Additionally, the motor is mechanically coupled to the drum/axle, such that the drum/axle rotates at the direction of the motor. The winch cable is coupled to the drum/axle, such that rotation of the drum/axle either retracts or extends the winch cable thereon, depending on the direction of rotation urged by the motor. A free end of the winch cable includes a winch hook thereon for attaching to an object to be pulled or for attaching to the winch cable after being wrapped around the object.

In one embodiment, the winch hook is a standard clevis slip hook. This winch hook offers a wide area to hold cables and straps. Further, most versions of this hook feature a small snapping clip that seals the hook area, preventing cables from escaping. This clip makes it easy to quickly wrap your cable around something and snap it closed without escaping any part of the hook. Other winch hooks can also be used with the device, such as winch shackles, thimbles, etc., or any other suitable winch hook as is known in the art.

In one embodiment, the battery for powering the device is positioned inside the base component. Typically, the battery is removable, such that a user can remove the battery as needed and replace the battery with a new battery. In another embodiment, the battery is rechargeable and can be removed and recharged, as needed. The battery may be recharged by coupling to a vehicle's charging system through a 12V cord, such as a cigarette lighter outlet or by 120V transformed current off the vehicle. Further, the battery within the base component comprises an adapter which is secured between the battery and the winch control box, to power the winch component.

In one embodiment, the winch component comprises a cable guide that receives the winch cable through an opening to align the winch cable with a proper section of the drum/axle, and to feed and retract the winch cable within a defined lateral position.

In one embodiment, the portable winch device comprises a remote control for controlling the winch component. The remote control is in communication with the battery and the motor to control the winch as is needed. Thus, the remote control remotely controls the operation of the winch component in order that a user may locate himself remotely from the winch device, out of the path of working objects and still use the device. The remote control would have several buttons, which act to control the motor between off, forward motion and reverse motion.

In one embodiment, the base component comprises soft shackles and/or carabiners which are positioned to come out the back side of the base component and are attached to the winch component inside the base component. The soft shackles and/or carabiners are used to anchor the base component in place. Specifically, the soft shackles and/or carabiners are attachable to a vehicle, tree, etc., or other suitable object to provide a solid stay. Further, soft shackles and carabiners do not have to be used and any suitable securing means can be used as is known in the art.

In one embodiment, the base component comprises a handle. Thus, if the portable winch device is to be used and moved distant from its location, a user can simply grasp the handle to lift the winch device to transport it to another location. The handle can be any suitable handle as is known in the art and is typically secured to the opposing right and left sides of the base component.

In yet another embodiment, the portable winch device comprises a plurality of indicia.

In yet another embodiment, a method of pulling an object is disclosed. The method includes the steps of providing a portable winch device comprising a base component with a winch component and removable battery inside. The method also comprises securing the soft shackles of the base component to an anchor. Further, the method comprises securing the winch hook of the winch component to the object to be pulled. Finally, the method comprises pulling the object to a desired location, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the portable winch device of the present invention showing the device and remote in accordance with the disclosed architecture;

FIG. 2 illustrates a perspective view of one embodiment of the portable winch device of the present invention showing the interior of the device in accordance with the disclosed architecture;

FIG. 3 illustrates a perspective view of one embodiment of the portable winch device of the present invention showing the winch component in accordance with the disclosed architecture;

FIG. 4 illustrates a perspective view of one embodiment of the portable winch device of the present invention showing the soft shackles at the rear of the device in accordance with the disclosed architecture;

FIG. 5 illustrates a perspective view of one embodiment of the portable winch device of the present invention showing the remote for controlling the device in accordance with the disclosed architecture; and

FIG. 6 illustrates a flowchart showing the method of pulling an object in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a portable winch device that provides users with a portable winch with its own power source that can be attached to anything. There is also a long felt need in the art for a portable winch device that assists users in moving heavy items off of the ground, pulling items onto trailers, pulling vehicles, etc. Further, there is a long felt need in the art for a portable winch device that includes an independent power source so that it can be operated in all scenarios. Moreover, there is a long felt need in the art for a device that ensures that a ready to use winch is on hand when needed. Further, there is a long felt need in the art for a portable winch device that comprises a small remote. Finally, there is a long felt need in the art for a portable winch device that is powered by a removable battery.

The present invention, in one exemplary embodiment, is a novel portable winch device. The device is a winch with its own power source so that it can be used at any time. The portable winch device comprises a base component that is configured in a rectangular box which encloses the winch component. The winch component is a 12v electric winch, powered by a removable battery. The removable battery sits inside the base component with an adapter to go from the battery to the winch control box for power. Further, soft shackles and/or carabiners are positioned to come out the back of the base component and are attached to the winch component inside the base component. The soft shackles are used to anchor the base component in place. Further, a small remote is used to control the device. The present invention also includes a novel method of pulling an object. The method includes the steps of providing a portable winch device comprising a base component with a winch component and removable battery inside. The method also comprises securing the soft shackles of the base component to an anchor. Further, the method comprises securing the winch hook of the winch component to the object to be pulled. Finally, the method comprises pulling the object to a desired location, as needed.

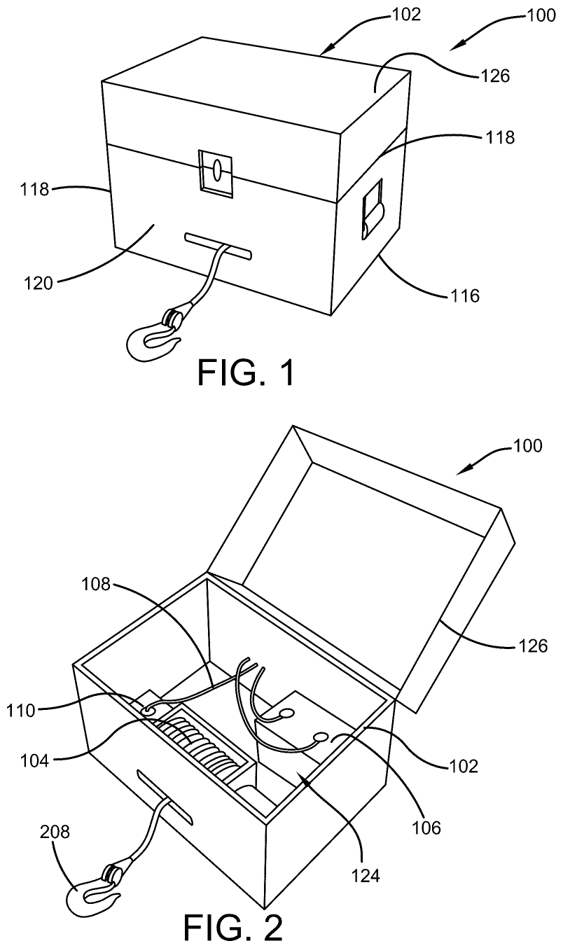

Referring initially to the drawings, FIG. 1 illustrates a perspective view of one embodiment of the portable winch device 100 of the present invention. In the present embodiment, the portable winch device 100 is an improved portable winch device 100 that provides a user with a portable winch with its own power source. Specifically, the portable winch device 100 comprises a base component 102 which encloses a winch component 104 and a removeable battery 106. The removable battery 106 sits inside the base component 102 with an adapter 108 to go from the battery 106 to a winch control box 110 for power. Further, soft shackles 112 and/or carabiners 114 are positioned to come out the back 122 of the base component 102 and are attached to the winch component 104 to anchor the base component 102 in place.

Generally, the portable winch device 100 is a winch with its own power source that can be attached to anything. The portable winch device 100 assists users in moving heavy objects off of the ground, pulling items onto trailers, pulling vehicles, etc., or any other suitable pulling of objects as is known in the art. The portable winch device 100 can be easily transported and ensures that a ready-to-use winch is on hand when needed.

Further, the portable winch device 100 comprises a base component 102 configured as a rectangular box which encloses a winch component 104. The base component 102 can be any suitable shape and size as is known in the art. Further, the base component 102 comprises a bottom 116, opposing right and left sides 118, opposing front 120 and back 122 sides, and an open interior 124 that houses the winch component 104. Typically, the open interior 124 is secured by a hinged lid component 126 or any other suitable lid component as is known in the art.

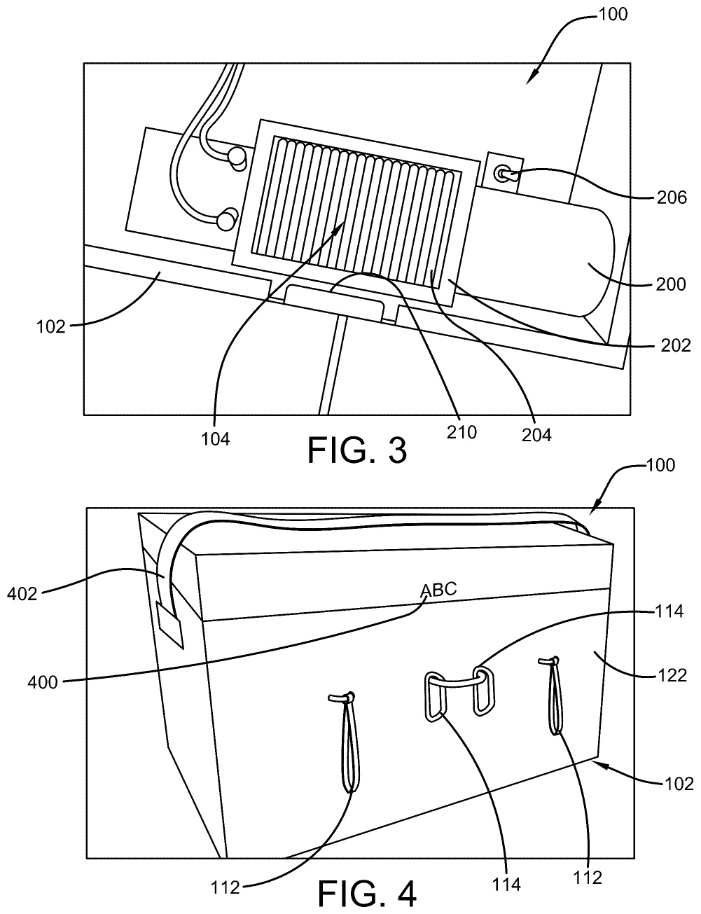

As shown in FIGS. 2-3, the winch component 104 is a 12v electric winch, powered by a removable battery 106. Specifically, the winch component 104 includes a motor 200, a drum/axle 202 coupled to the motor 200, and a winch cable 204. The motor 200 is electrically coupled to the battery 106 and is selectively operated by a winch control box 110. Further, upon activation from the winch control box 110, the winch control box 110 draws power from the battery 106 to provide power to the winch component 104. The motor 200 is electrically driven and connects via suitable circuitry with the battery 106 of the device 100. Further, a control toggle switch 206 acts to control the motor 200 between off, forward motion and reverse motion. This winch component 104 typically has a 2500 pound stall capacity, however winches of more or less capacity could be adapted to operate with the device 100 of the invention.

Additionally, the motor 200 is mechanically coupled to the drum/axle 202, such that the drum/axle 202 rotates at the direction of the motor 200. The winch cable 204 is coupled to the drum/axle 202, such that rotation of the drum/axle 202 either retracts or extends the winch cable 204 thereon, depending on the direction of rotation urged by the motor 200. A free end of the winch cable 204 includes a winch hook 208 thereon for attaching to an object to be pulled or for attaching to the winch cable 204 after being wrapped around the object.

In one embodiment, the winch hook 208 is a standard clevis slip hook. This winch hook 208 offers a wide area to hold cables and straps. Further, most versions of this hook feature a small snapping clip that seals the hook area, preventing cables from escaping. This clip makes it easy to quickly wrap your cable around something and snap it closed without escaping any part of the hook. Other winch hooks 208 can also be used with the device 100, such as winch shackles, thimbles, etc., or any other suitable winch hook 208 as is known in the art.

Furthermore, the battery 106 for powering the device 100 is positioned inside the base component 102. Typically, the battery 106 is removable, such that a user can remove the battery 106 as needed and replace the battery 106 with a new battery 106. In another embodiment, the battery 106 is rechargeable and can be removed and recharged, as needed. The battery 106 may be recharged by coupling to a vehicle's charging system through a 12V cord, such as a cigarette lighter outlet or by 120V transformed current off the vehicle. Further, the battery 106 within the base component 102 comprises an adapter 108 which is secured between the battery 106 and the winch control box 110, to power the winch component 104.

The battery 106 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the portable winch device 100. Throughout this specification, the term “battery” may be used interchangeably to refer to one or more wet or dry cells or batteries of cells in which chemical energy is converted into electricity and used as a source of DC power. References to recharging or replacing the battery 106 may refer to recharging or replacing individual cells, individual batteries of cells, or a package of multiple battery cells as is appropriate for any given battery technology that may be used. In addition, a rechargeable embodiment of the battery 106 may be recharged using a USB port (not shown), wherein the USB port is a USB-A, USB-B, Micro-B, Micro-USB, Mini-USB, or USB-C port, etc.

In one embodiment, the winch component 104 comprises a cable guide 210 that receives the winch cable 204 through an opening to align the winch cable 204 with a proper section of the drum/axle 202, and to feed and retract the winch cable 204 within a defined lateral position.

As shown in FIG. 4, the base component 102 comprises soft shackles 112 and/or carabiners 114 which are positioned to come out the back side 122 of the base component 102 and are attached to the winch component 104 inside the base component 102. The soft shackles 112 and/or carabiners 114 are used to anchor the base component 102 in place. Specifically, the soft shackles 112 and/or carabiners 114 are attachable to a vehicle, tree, etc., or other suitable object to provide a solid stay. Further, soft shackles 112 and carabiners 114 do not have to be used and any suitable securing means can be used as is known in the art.

In one embodiment, the base component 102 comprises a handle 402. Thus, if the portable winch device 100 is to be used and moved distant from its location, a user can simply grasp the handle 402 to lift the winch device 100 to transport it to another location. The handle 402 can be any suitable handle as is known in the art and is typically secured to the opposing right and left sides 118 of the base component 102 via any suitable securing means as is known in the art, such as welding, adhesives, mechanical fasteners, etc. Further, the handle 402 can be any suitable handle as is known in the art, as long as the handle 402 allows a user to securely and comfortably retain the device 100 within their hand. Additionally, the handle 402 can comprise gripping texture areas or other suitable non-slip resistant areas to provide a non-slip grip for a user.

In yet another embodiment, the portable winch device 100 comprises a plurality of indicia 400. The base component 102 of the device 100 may include advertising, a trademark, or other letters, designs, or characters, printed, painted, stamped, or integrated into the base component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be winch, portable, or brand related.

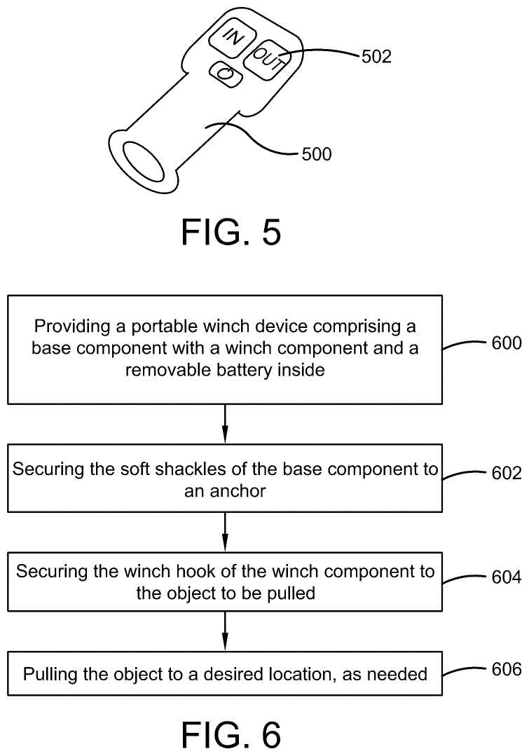

As shown in FIG. 5, the portable winch device 100 comprises a remote control 500 for controlling the winch component 104. The remote control 500 is in communication with the battery 106 and the motor 200 to control the winch component 104 as is needed. Thus, the remote control 500 remotely controls the operation of the winch component 104 in order that a user may locate himself/herself remotely from the winch device 100, out of the path of working objects and still use the device 100. Further, the remote control 500 would have several buttons 502, which act to control the motor 200 between on/off, forward motion and reverse motion.

FIG. 6 illustrates a flowchart of the method of pulling an object. The method includes the steps of at 600, providing a portable winch device comprising a base component with a winch component and removable battery inside. The method also comprises at 602, securing the soft shackles of the base component to an anchor. Further, the method comprises at 604, securing the winch hook of the winch component to the object to be pulled. Finally, the method comprises at 606, pulling the object to a desired location, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “portable winch device”, “portable device”, “winch device”, and “device” are interchangeable and refer to the portable winch device 100 of the present invention.

Notwithstanding the forgoing, the portable winch device 100 of the present invention can be of any suitable size and configuration as is known in the art without affecting the overall concept of the invention, provided that it accomplishes the above stated objectives. One of ordinary skill in the art will appreciate that the portable winch device 100 as shown in FIGS. 1-6 is for illustrative purposes only, and that many other sizes and shapes of the portable winch device 100 are well within the scope of the present disclosure. Although the dimensions of the portable winch device 100 are important design parameters for user convenience, the portable winch device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable winch device that provides a user with a portable winch with its own power source, the portable winch device comprising:
a base component;
a winch component; and
a battery;
wherein the base component encloses the winch component and the battery;
wherein the winch component is secured to an object to be pulled;
wherein the battery provides power to the winch component; and
further wherein the portable winch device is easily transported and assists users in moving heavy objects.

2. The portable winch device of claim 1, wherein the base component is configured as a rectangular box comprising a bottom, opposing right and left sides, opposing front and back sides, and an open interior that houses the winch component.

3. The portable winch device of claim 2, wherein the open interior is secured by a hinged lid component.

4. The portable winch device of claim 3, wherein the winch component is a 12v electric winch, powered by the battery.

5. The portable winch device of claim 4, wherein the winch component includes a motor, a drum/axle coupled to the motor, and a winch cable.

6. The portable winch device of claim 5, wherein the motor is electrically coupled to the battery and is selectively operated by a winch control box to draw power from the battery to provide power to the winch component.

7. The portable winch device of claim 6, wherein a control toggle switch acts to control the motor between on/off, forward motion and reverse motion.

8. The portable winch device of claim 7, wherein the motor is mechanically coupled to the drum/axle, such that the drum/axle rotates at the direction of the motor, and the winch cable is coupled to the drum/axle, such that rotation of the drum/axle either retracts or extends the winch cable, depending on direction of rotation urged by the motor.

9. The portable winch device of claim 8, wherein a free end of the winch cable includes a winch hook thereon for attaching to an object to be pulled or for attaching to the winch cable after being wrapped around the object.

10. The portable winch device of claim 9, wherein the battery is positioned inside the base component and is removable.

11. The portable winch device of claim 10, wherein the battery comprises an adapter which is secured between the battery and the winch control box, to power the winch component.

12. The portable winch device of claim 11, wherein the base component comprises soft shackles and carabiners which are positioned to come out the back side of the base component.

13. The portable winch device of claim 12, wherein the soft shackles and carabiners are attached to the winch component inside the base component and used to anchor the base component in place.

14. A portable winch device that provides a user with a portable winch with its own power source, the portable winch device comprising:
a base component configured as a rectangular box comprising a bottom, opposing right and left sides, opposing front and back sides, and an open interior;
a winch component housed within the base component; and
a battery positioned inside the base component and is removable;
wherein the open interior is secured by a hinged lid component;
wherein the winch component includes a motor, a drum/axle coupled to the motor, and a winch cable;
wherein the motor is electrically coupled to the battery and is selectively operated by a winch control box to draw power from the battery to provide power to the winch component;
wherein the motor is mechanically coupled to the drum/axle, such that the drum/axle rotates at the direction of the motor, and the winch cable is coupled to the drum/axle, such that rotation of the drum/axle either retracts or extends the winch cable, depending on direction of rotation urged by the motor;
wherein a free end of the winch cable includes a winch hook thereon for attaching to an object to be pulled or for attaching to the winch cable after being wrapped around the object;
wherein a cable guide receives the winch cable through an opening to align the winch cable with a proper section of the drum/axle, and to feed and retract the winch cable within a defined lateral position;
wherein the battery comprises an adapter which is secured between the battery and the winch control box, to power the winch component;
wherein the base component comprises soft shackles and carabiners which are positioned to come out the back side of the base component;
wherein the soft shackles and carabiners are attached to the winch component inside the base component and used to anchor the base component in place; and
further wherein the portable winch device is easily transported and assists users in moving heavy objects.

15. The portable winch device of claim 14, wherein the battery is rechargeable and can be removed and recharged, as needed.

16. The portable winch device of claim 14 further comprising a handle for transportation.

17. The portable winch device of claim 14 further comprising a plurality of indicia.

18. The portable winch device of claim 14 further comprising a remote control in communication with the battery and the motor to control the winch component remotely.

19. The portable winch device of claim 18, wherein the remote control has several buttons, which act to control the motor between on/off, forward motion and reverse motion.

20. A method of pulling an object, the method comprising the following steps:
providing a portable winch device comprising a base component with a winch component and removable battery inside;
securing the soft shackles of the base component to an anchor;
securing the winch hook of the winch component to the object to be pulled; and
pulling the object to a desired location, as needed.
